(19) United States
(12) Patent Application Publication
(10) Pub. No.: US 2009/0227369 A1
(43) Pub. Date: Sep. 10, 2009

(54) Amusement Device Having a Configurable Display for Presenting Games Having Different Aspect Ratios

(75) Inventors: Colin Higbie, Southampton, PA (US); James R. Stelzer, Holland, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Merit Entertainment, Bristol, PA (US)

(21) Appl. No.: 12/045,067

(22) Filed: Mar. 10, 2008

(51) Int. Cl. A63F 13/00

(52) U.S. Cl. 463/31

(57) ABSTRACT

An amusement device includes a display screen having a first aspect ratio and a currency input. The amusement device is operable by a user upon receipt by the currency input of at least one of coins, currency, and a credit card/debit card. A controller is configured to select and execute at least one application program and at least one secondary application. The at least one application program is configured to display at least one first image on the display screen in a second aspect ratio. The at least one first image is displayed in the second aspect ratio in a first portion of the display screen. The second aspect ratio is different than the first aspect ratio. The at least one secondary application is configured to display at least one second image in the second portion of the display screen.

### BACKGROUND OF THE INVENTION

Embodiments of the present invention relate generally to electronic amusement devices and systems. More particularly, one embodiment is directed to an electronic amusement device wherein a display screen and an application running on the amusement device have different aspect ratios. Another embodiment is directed to an electronic amusement device wherein a screen and a bezel comprise an individual assembly. A still further embodiment is directed to an amusement system having a credit card transaction terminal separate from the amusement device.

Amusement devices having electronic games for computers and touchscreens or other types of amusement devices are generally well known in the art. Amusement devices, such as game machines, which allow a user to select games from a video display are well known in the art, such as those disclosed in U.S. Pat. Nos. 4,856,787 (“Itkis”); 5,575,717 (“Houriet, Jr., et al.”); 5,743,799 (“Houriet, Jr., et al.”), the entire contents of which are incorporated by reference herein, each of which shows a touchscreen for making a game selection from a menu of games. Such game machines or amusement devices typically operate upon input of currency (i.e., coin, token, paper money, credit/debit cards or the like) and are installed in locations such as bars, restaurants, airports, shopping malls, video arcades, casinos or the like. The game choices may include card games, sports games, games of skill, games of chance, action games, trivia games, or the like.

Electronic amusement devices have typically housed display screens following the standard television aspect ratio of 4:3. Applications, including games or the like, were therefore presented to the user on the screen in the 4:3 format, leaving no empty space. However, there has been a trend toward manufacturing display screens having a “widescreen” format, usually a ratio of 16:9 or 16:10. Despite the shift toward widescreen amusement devices, many games, especially older games, are still presented on the screen in 4:3 format. As a result, manufacturers are forced to either stretch the game picture to fit the entire screen, thereby distorting the images, or present the game in 4:3 format with empty space on either side of the screen (known as pillarboxing).

In addition, users of electronic games are generally provided with one or more physical controls, such as a joystick, keyboard, trackball, pushbuttons, or the like, for controlling play of the game. With the development of touchscreen technology, there has been a further trend toward using virtual controls, i.e., manipulatable on-screen images capable of mimicking the inputs of a joystick, trackball, or the like.

The perimeter of the touchscreen is typically surrounded by a plastic cover or bezel. The touchscreen and bezel are assembled together as separate piece. As a result, the screen and bezel have a relatively high profile. Additionally, the seal between the touchscreen and the bezel may not be water-tight, allowing fluid to seep into the space between and potentially damaging the touchscreen assembly.

It is therefore desirable to provide an amusement device capable having a widescreen display that is capable of maximizing the use of the display area without distorting application images. It is further desirable to provide an amusement device with a water-tight touchscreen display having a lower profile.

### BRIEF SUMMARY OF THE INVENTION

Briefly stated, various embodiments of the present invention comprise an amusement device including a display screen having a first aspect ratio and a touchscreen. The amusement device is operable by a user upon receipt by a currency input of at least one of coins, currency, and a credit card/debit card. A controller is configured to select and execute at least one application program and at least one virtual control application. The at least one application program is configured to display at least one first image on the display screen in a second aspect ratio. The at least one first image is displayed in the second aspect ratio in a first portion of the display screen. The second aspect ratio is different than the first aspect ratio. The at least one virtual control application is configured to display at least one second image in the second portion of the display screen.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1A is a perspective view of an amusement device in accordance with a first preferred embodiment of the present invention;

FIG. 1B is a perspective view of an amusement device in accordance with a second preferred embodiment of the present invention;

FIG. 2A is a prior art screenshot of a game image having a 4:3 aspect ratio displayed on an amusement device having a widescreen aspect ratio;

FIG. 2B is another prior art screenshot of a game image designed for a 4:3 aspect ratio displayed on an amusement device having a widescreen aspect ratio;

FIG. 3 is a screenshot of a game image having a 4:3 aspect ratio and a virtual control image in accordance with preferred embodiments of the present invention;

FIG. 4 is a screenshot of a game image having a 4:3 aspect ratio and peripheral advertising in accordance with preferred embodiments of the present invention;

FIG. 5 is a screenshot of a game image having a 4:3 aspect ratio, a virtual control image, and peripheral advertising in accordance with preferred embodiments of the present invention;

FIG. 6 is a perspective exploded view of a touchscreen assembly according to a preferred embodiment of the present invention; and

FIG. 7 is a perspective view of the touchscreen assembly of FIG. 6.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the amusement device and designated parts thereof. The terminology includes the above-listed words, derivatives thereof, and words of similar import. Additionally, the words “a” and “an”, as used in the claims and in the corresponding portions of the specification, mean “at least one.” Further, the terms “coin” or “currency” should not be construed as limiting and can be used herein to mean all forms of coin and paper currency from any country as well as proprietary tokens, game cards, credit cards, debit cards, chits, or other representative forms of credit and/or payment.

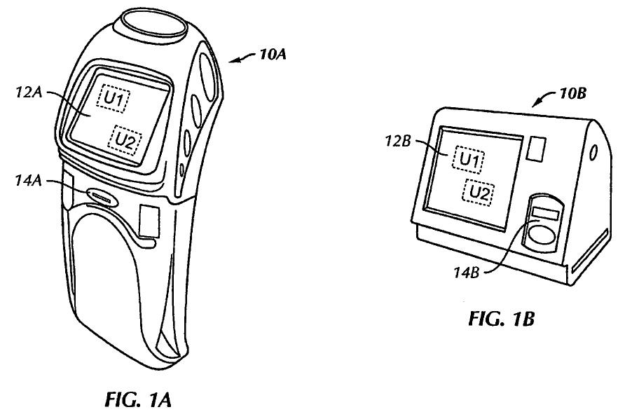

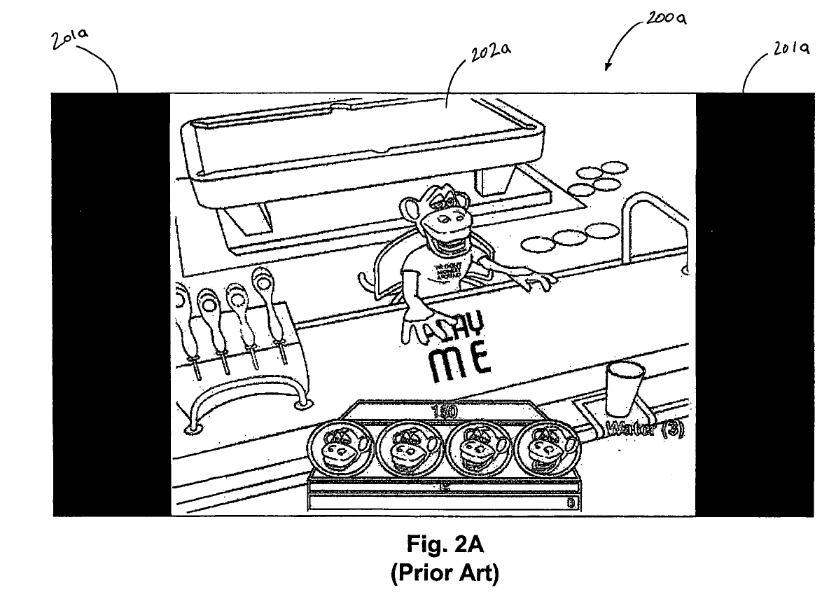

Referring to the drawings in detail, wherein like reference numerals indicate like elements throughout, there is shown in FIG. 1A a first preferred embodiment of an amusement device 10A. The amusement device 10A includes a controller U1 and a memory U2. The memory U2 can be any known or suitable memory device such as random access memory (RAM), read only memory (ROM), flash RAM, hard disk, optical disk, or the like. The amusement device 10A further includes a video display 12A that is operatively connected to the controller U1. The amusement device 10A also includes at least one input component 14A that receives value in order to establish one or more playable credits. The value received may be at least one of currency, coins, tokens, chits, credits, credit cards/debit cards or the like. Although only one input component 14A is shown, the amusement device 10A may include more than one input component 14A to give a user an option for payment, for permitting multiple players, or the like. Preferably, the amusement device 10A is made operable upon actuation of the input component 14A, for example, the user may only select and play an electronic game once value is received at the input component 14A and/or one or more playable credits are issued to the user. However, free selections may be offered at the discretion of an operator of the amusement device 10A.

FIG. 1B shows another or second amusement device 10B in accordance with a second preferred embodiment of the present invention. The second amusement device 10B also includes a controller U1, a memory U2, a display 12B, and an input component 14B. Preferably, the video displays 12A, 12B are touchscreen video displays configured to accept touch input. The first amusement device 10A is a free-standing or floor-standing apparatus, whereas the second amusement device 10B is a table-top or counter-top apparatus. However, the amusement devices 10A, 10B may be arranged in any configuration including table mount, wall mount, pole mount, and the like without departing from the invention.

For convenience, the amusement devices 10A, 10B will be referred to hereinafter simply as “amusement device 10.”

Turning now to the operation of the amusement device 10, the memory U2 stores one or more application programs, such as electronic games, a music or video jukebox program, or the like, and a system control program. However, the one or more application programs may also be stored remotely. The controller U1 controls the touchscreen display 12 based upon the system control program retrieved from the memory U2 and based upon inputs from the touchscreen display 12. As used herein, the system control program refers to all of the software functions outside of the application program files including an operating system, display control, input control, sound drivers, and the like. Other input devices which may be connected to the amusement device 10 include a pushbutton(s), a trackball or touchpad, a mouse, a joy-stick, a foot-pedal, a voice recognition system, a keypad or keyboard, and the like. But, preferably, the input device is the touchscreen display 12.

The amusement device 10 includes an operating mode and a setup mode. When the operating mode is selected, a player or user is selectively permitted to access the application programs. When the setup mode is selected, the owner/operator is permitted to make system setup adjustments. To switch from the operating mode to the setup mode, a mode selector pushbutton (hardware not shown) is provided that is typically concealed from the users. The mode selector pushbutton may be implemented as a hidden software feature, but preferably the mode selector pushbutton is a simple pushbutton that is disposed inside a housing of the amusement device 10. In the setup mode, the owner/operator may also make adjustments to the game features as will be described in greater detail hereinafter.

In the preferred embodiments of the present invention, the controller U1 controls the display 12 based upon the system control program retrieved from the memory U2 and based upon inputs of the user. The display 12 preferably has a “widescreen” aspect ratio. Such ratios may include, for example, 16:9, 16:10, 1.85:1, 2.35:1, or the like. The controller U1 is configured to select and execute at least one application program. The application program is preferably configured to display at least one first image on the display 12 in a second aspect ratio different than the display 12 aspect ratio, such as 4:3.

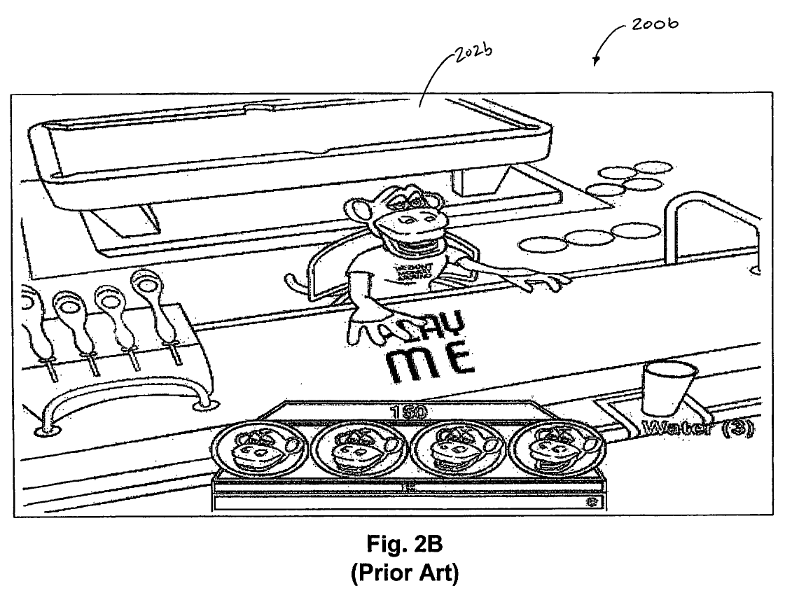

As described above, prior art amusement devices encountered difficulties in presenting a game configured to display images in a different aspect ratio than the display screen. For example, FIG. 2A is a prior art screenshot 200a from an amusement device 10. The controller U1 is executing an application program (e.g., an electronic game) that is configured to display the game image 202a in a 4:3 aspect ratio. Since the screen 200a has a widescreen aspect ratio, black bars 201a on either side of the game image 202a are effectively dead space. In FIG. 2B, the game image 202b is stretched to fill the entire screen 200b. The dead space found in FIG. 2A is eliminated, but the game images 202b are now horizontally distorted.

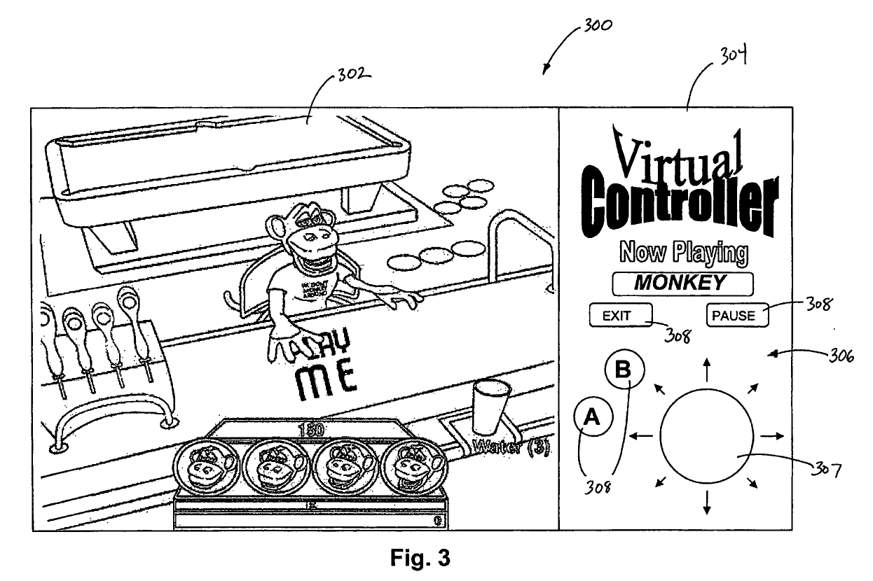

FIG. 3 is a screenshot 300 from an amusement device 10 in accordance with a preferred embodiment of the present invention. The screen 300 presents the game image 302 in its proper 4:3 format. The screen 300 includes a remainder portion 304 that is not occupied by the game image 302. Rather than allow the remainder portion 304 to become dead space, the controller U1 executes at least one secondary application to provide at least one secondary application image 306 in the remainder portion 304. In FIG. 3, the secondary application is a virtual control application configured to display a “virtual controller” image 306. The virtual control application may include a virtual trackball and corresponding trackball image 307 and/or virtual pushbuttons and corresponding button images 308 for manipulating the electronic game. Other virtual inputs and corresponding images not shown may be included, such as a virtual mouse, virtual joystick, or the like. The virtual control application and control image 306 may be provided as the sole input for the electronic game, but may also be in addition to other physical input devices as described above.

The control image 306 may be specific to the electronic game currently being played, that is, the control element images 307, 308 may be tailored exclusively for manipulation of the specific game. For example, the trackball image 307 may only be displayed or provided for games in which a trackball is necessary. The control image 306 may also be constantly displayed for all electronic games or other applications. For example, the trackball image 307 and pushbutton images 308 may be displayed by the amusement device 10 for all application programs, whether or not a particular control element image 307, 308 is used for the current application program.

When using a virtual input, such as a virtual trackball, it may be difficult for a user to determine that his or her hand is correctly positioned over the trackball image 307 without looking at the trackball image 307. This may hinder the user's ability to play the game. Therefore, the display 12 may preferably be provided with at least one textured element (not shown) to aid the user in determining hand placement on the touchscreen 12. The textured element may be a bump, ridge, divot, cavity, or the like in the screen 12 that enables the user to find the trackball image 307 or other element of the control image 306 somatically rather than visually.

In preferred embodiments, the control image 306 is movable to a location on the screen 300 desired by the user. For example, the control image 306 in FIG. 3 is located on the right side of the screen 300. A left-handed user may desire to have the control image 306 on the left side of the screen 300, thus moving the game image 302 to the right side of the screen 300. The user may use any method known in the art for positioning the control image 306 to a desired location on the screen 300 not occupied by the game image 302. For example, the user may “drag and drop” the control image 306 (or the game image 302) from one location on the screen 300 to another. There may also be physical or virtual buttons or switches (not shown) for selecting from pre-designated locations to position the control image 306. In certain preferred embodiments, the elements of the control image 306 may be divided among different screen 300 areas. For example, one or more of the pushbutton images 308 may be located on the left side of the screen 300 and the trackball image 307 may be located on the right side of the screen 300, with the game image 302 being located in the center of the screen 300.

In accordance with the virtual control application and control image 306, the display 12 may preferably be configured to accept simultaneous input from at least two locations on the touchscreen 12. For example, a user may preferably touch the trackball image 307 and a pushbutton image 308 simultaneously and have the input from both locations on the touchscreen 12 be accepted by the controller U1. The user may thus, for example, move a game character on the display 12 (via the trackball) and fire (via the pushbutton) simultaneously within the context of the game.

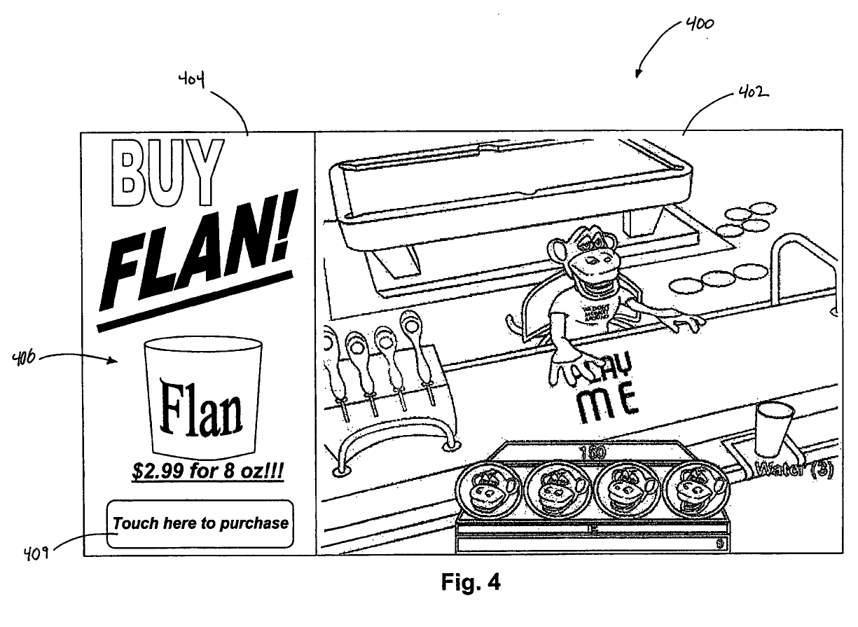

FIG. 4 is a screenshot 400 from an amusement device 10 in accordance with another preferred embodiment of the present invention. The screen 400 presents the game image 402 in its proper 4:3 format and includes the remainder portion 404. In FIG. 4, the secondary application is an advertisement application providing an ad image 406 that occupies the entire remainder portion 404 of the screen 400. Alternatively, the advertisement application may provide a plurality of ad images 406 simultaneously visible in the remainder portion 404. Still further, the advertisement application may provide one or more ad images 406 presented to the user in the remainder portion 404 on a rotating basis, i.e., the ad image 406 may change intermittently as desired by the operator or advertiser.

The advertisement application and corresponding ad image 406 are preferably user interactive. For example, the ad image 406 includes a purchase button 409. A user may select the purchase button 409 if he or she desires to purchase the advertised product and may be presented with, for example, an internet or network ordering page. In addition, a user may be able to touch different portions of the ad image 406 to learn more about the product, view demonstrations, proceed to a shopping web site, or the like. For embodiments having interactive advertisements, the application program should be paused or halted to allow the user to proceed with researching or purchasing the product. The application program may resume once the transaction is complete.

In preferred embodiments, the ad image 406 is movable to a location on the screen 400 desired by the user. For example, the ad image 406 in FIG. 4 is located on the left side of the screen 400, but may be optionally located by the user to the right side of the screen 400. The user may use any method known in the art for positioning the ad image 406 to a desired location on the screen 400 not occupied by the game image 402. For example, the user may “drag and drop” the ad image 406 (or the game image 402) from one location on the screen 400 to another. There may also be physical or virtual buttons or switches (not shown) for selecting from pre-designated locations to position the ad image 406. In certain preferred embodiments, the ad image 406 may include one or more ads divided among different screen 400 areas. For example, one or more ads may be located on the left side of the screen 400 and other ads may be located on the right side of the screen 400, with the game image 402 being located in the center of the screen 400.

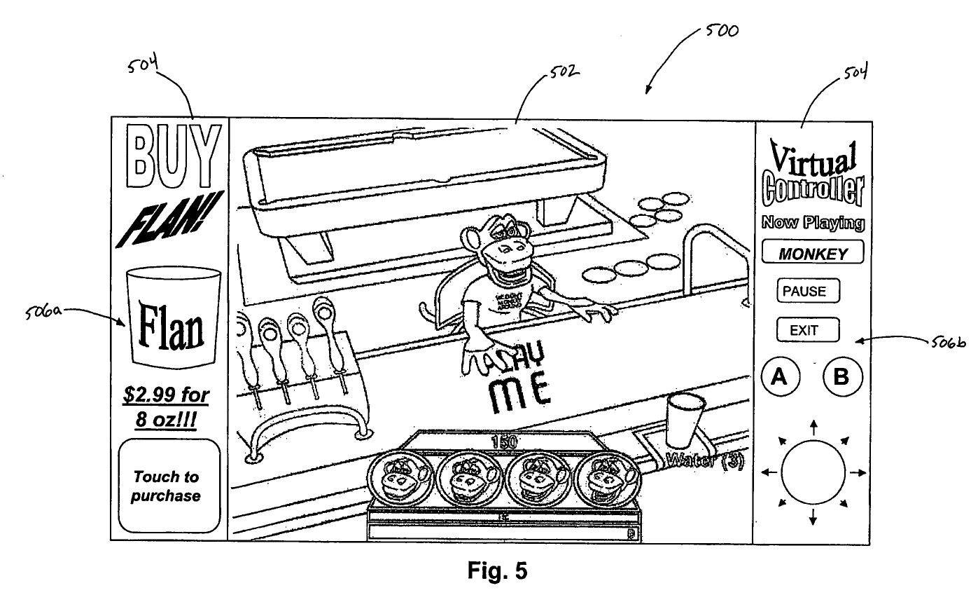

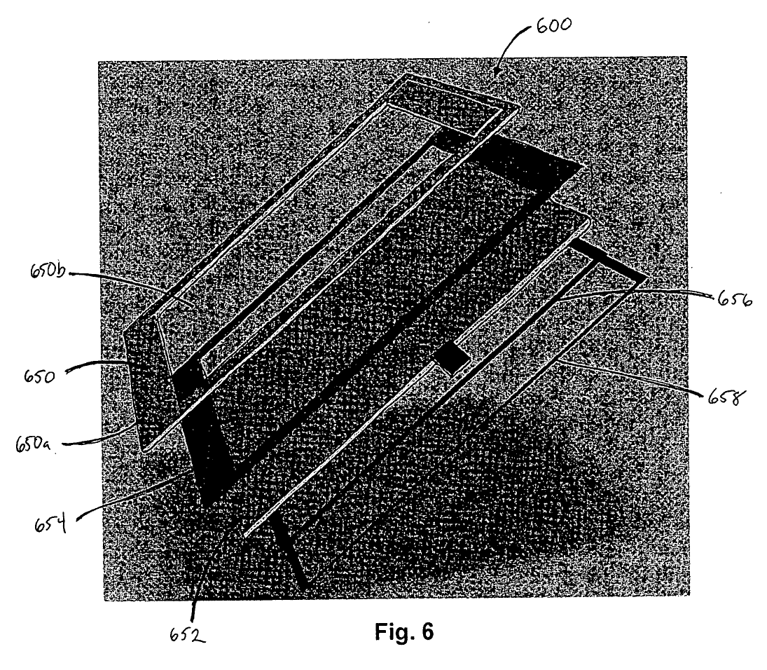

FIG. 5 is a screenshot 500 from an amusement device 10 in accordance with a still further preferred embodiment of the present invention. The screen 500 presents the game image 502 in its proper 4:3 format and includes the remainder portion 504. The controller U1 is executing a plurality of secondary applications to provide multiple secondary application images 506a, 506b. For example, an advertisement application provides an ad image 506a (as described above with respect to FIG. 4) on the left side of the screen 500, a virtual control application provides a control image 506b (as described above with respect to FIG. 3) on the right side of the screen 500, and the game image 502 is presented in the center of the screen 500. As described above, in preferred embodiments, both the ad image 506a and the control image 506b are movable to locations on the screen 500 desired by the user. For example, the user may choose to locate the ad image 506a and the control image 506b on the same side of the screen 500.

It is understood by those skilled in the art that embodiments of the present invention are not limited to the descriptions provided above. For example, the application program may be one or more of an electronic game, music or video jukebox controller, web browser, streaming media file, electronic mail or the like. Similarly, the secondary applications may include virtual control applications, advertisement applications, virtual light display applications, movies, music, web browser, electronic mail, pager, messaging, or the like. Additionally, the aspect ratio of the image displayed by the application program is not limited to 4:3, and may encompass any aspect ratio that is different from the screen aspect ratio and leaves available screen space. For example, an application program having a ratio of 2.35:1 will leave available space at the top and bottom of a 16:9 screen.

In preferred embodiments, the amusement device 10 utilizes a water-tight touchscreen display 12 having a low profile. For example, FIG. 6 shows an exploded view of an assembly 600 for use in the touchscreen display 12. The assembly 600 includes a bezel 650 and a touch sensor 652. The bezel 650 is composed of a frame 650a defining an opening 650b for the display 12. The frame 650a is preferably constructed of a plastic or other durable material. The touch sensor 652 is preferably a projective capacitive type sensor, although other types (e.g, resistive, infrared, or the like) may be used.

The touch sensor 652 is permanently or semi-permanently affixed to the bezel 650 using a strong front adhesive layer 654, such as an acrylic foam tape or the like. The front adhesive layer 654 preferably corresponds to the shape of the frame 650a such that the opening 650b is not obscured by the front adhesive layer 654. Similarly, a perimeter of the touch sensor 652 is preferably smaller than a perimeter of the bezel 650, leaving a portion of the front adhesive layer 654 exposed for use in, for example, affixing the assembly 600 to the amusement device 10.

A rear gasket 656 is disposed on a side of the touch sensor 652 opposite the bezel 650. The rear gasket 656 provides a seal between the touch sensor 652 and the display 12. A rear adhesive layer 658 is also affixed around a perimeter of the touch sensor 652 on the side opposite the bezel 650. The rear adhesive layer 658 may be used, for example, to affix the assembly 600 to the amusement device 10, and is preferably of the same type as the front adhesive layer 654.

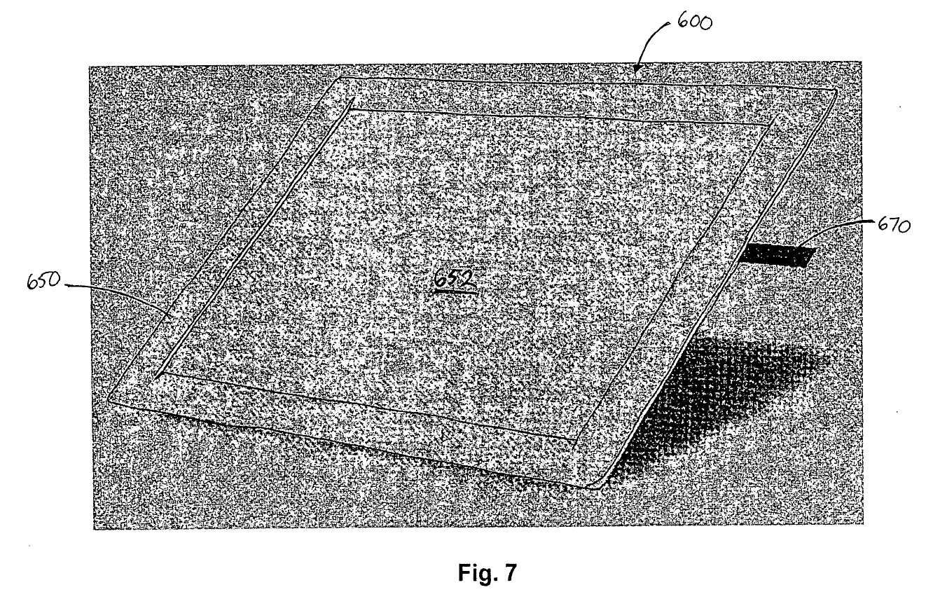

FIG. 7 is a perspective view of the completed assembly 600, wherein the bezel 650 and touch sensor 652 are permanently or semi-permanently adhered to one another for installation as a single unit onto a display 12 of the amusement device 10. A tail 670 of the touch sensor 652 provides an electrical connection between the touch sensor 652 and the amusement device 10. In preferred embodiments, the assembly 600 may provide a “plug and play” functionality, wherein the assembly 600 may be simply mounted onto the display 12, the tail 670 may be connected, and the amusement device 10 would thereafter be instantly operable. As viewed in FIG. 7, the assembly 600 provides a lower profile than conventional touchscreen installations.

The amusement device 10 may also include other functionality and features such as music jukebox, video jukebox, multimedia player, Internet browsing, broadcast media viewing, time based rental mode, non-prize tournaments, prize-based tournaments, head-to-head competitions, prize-based lotteries, ticket dispensing, prize dispensing, debit/credit card charging, phone card dispensing, e-mail, photography, placing customer orders, communicating with other amusement devices, and the like.

The amusement device 10 may also provide for remote or local access for accounting and/or bookkeeping purposes. The amusement device 10 may include a local connector for uploading to a hand-held or portable computer or removable memory for receiving accounting or other data. The amusement device 10 may include accounting and bookkeeping screens accessible by an operator through set up screens and/or through password protection.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An amusement device comprising:
(a) a display screen having a first aspect ratio and a touchscreen;
(b) a currency input, the amusement device being operable by a user upon receipt by the currency input of at least one of coins, currency, and a credit card/debit card; and
(c) a controller configured to select and execute at least one application program and at least one virtual control application, the at least one application program being configured to display at least one first image on the display screen in a second aspect ratio, the at least one first image being displayed in the second aspect ratio in a first portion of the display screen, the second aspect ratio being different than the first aspect ratio, the at least one virtual control application being configured to display at least one second image in the second portion of the display screen.

2. The amusement device of claim 1, wherein the at least one application program is an electronic game.

3. The amusement device of claim 2, wherein the at least virtual control application is configured to manipulate the electronic game.

4. The amusement device of claim 3, wherein the virtual control application includes at least one of a virtual trackball and a virtual joystick.

5. The amusement device of claim 3, wherein the user may selectively reposition at least one displayed element of the virtual control application within the second portion of the display screen.

6. The amusement device of claim 3, wherein the display screen includes at least one textured element on the second portion of the display screen, the at least one textured element being linked with at least one displayed element of the virtual control application.

7. The amusement device of claim 1, wherein the touchscreen comprises a touch sensor and a bezel, the touch sensor being one of permanently and semi-permanently affixed to the bezel to form a single unit.

8. The amusement device of claim 7, wherein an adhesive layer is disposed between the touch sensor and the bezel.

9. The amusement device of claim 8, wherein the adhesive layer is an acrylic foam tape.

10. The amusement device of claim 7, wherein the touch sensor is of a projective capacitive type.

11. The amusement device of claim 1, wherein the second aspect ratio is 4:3.

12. The amusement device of claim 11, wherein the first aspect ratio is one of 16:9, 16:10, 1.85:1, and 2.35:1.

13. The amusement device of claim 1, wherein the user may selectively reposition at least one of the first and second portions of the display screen with respect to the other of the first and second portions of the display screen.

14. The amusement device of claim 1, wherein the touchscreen permits simultaneous input from at least two different locations of the touchscreen.

15. The amusement device of claim 1, wherein the virtual control application is configured to manipulate a plurality of application programs.

16. The amusement device of claim 1, wherein displayed elements of the virtual control application are based on the application program being executed by the controller.
